(19) United States
(12) Patent Application Publication
(10) Pub. No.: US 2018/0094617 A1
(43) Pub. Date: Apr. 5, 2018

(54) Device and Method to Convert Reciprocating Linear Motion into Linear Fluid Flow

(71) Applicant: RICHARD NEIFELD, FAIRFAX, VA (US)

(72) Inventor: RICHARD NEIFELD, FAIRFAX, VA (US)

(21) Appl. No.: 15/725,235

(22) Filed: Oct. 4, 2017

Related U.S. Application Data
(60) Provisional application No. 62/403,852, filed on Oct. 4, 2016.

(51) Int. Cl. F03B 17/00; F03C 1/047; F03C 1/00; F03B 3/04; H02K 7/06

(52) U.S. Cl. CPC F03B 17/005; F03C 1/047; H02K 7/06; F03B 3/04; F03C 1/002

(57) ABSTRACT

The invention provides a device and method for converting reciprocating motion of various amplitudes and frequencies into unidirectional fluid flow, comprising a piston section and a valves section. The unidirectional fluid flow may then be used for various processes including for example conversion to mechanical or electrical power.

### SUMMARY OF THE INVENTION

The invention provide a device and methods of use of the device that include a piston section, a valves section, and a pneumatic generator section, that use a closed fluid circuit to convert reciprocating linear motion into linear fluid flow. This linear fluid flow can be used for various processes, including conversion into rotary mechanical power and electrical power.

### OBJECTS OF THE INVENTION

One object of this invention is to provide for efficient conversion of reciprocating motion over a broad range of amplitudes and broad range of frequencies of the reciprocating motion, into linear flow. Another object is to provide rotary mechanical or electrical power from the conversion.

### SUMMARY OF THE INVENTION

The invention provides a device and method for converting reciprocating motion into unidirectional fluid flow, comprising:

a piston section;

a valves section;

wherein the piston section comprising a piston chamber housing a piston head;

wherein said piston chamber (1) comprises a piston chamber seal side end (70), piston chamber non-seal side end (71), and piston chamber peripheral side wall (72);

wherein said piston chamber seal side end and said piston chamber non-seal side end define opposite ends of said piston chamber; wherein said piston chamber seal side end has surfaces that define a seal side aperture (6); wherein said piston chamber non-seal side end has surfaces that define non seal side aperture (7) so that said seal side aperture and said non seal side aperture are in opposite ends of said piston chamber;

wherein said valve section comprises a first pneumatic line connecting to the piston chamber via said seal side aperture in said piston chamber seal side end;

wherein said valve section comprises a second pneumatic line connecting to the piston chamber via said non seal side aperture in said piston chamber non-seal side end;

wherein said valve section comprises at least four one way valves;

wherein said valve section is configured to pass fluid out of said piston chamber via said seal side aperture in said piston chamber seal side end and to pass fluid into said piston chamber via said non seal side aperture in said piston chamber non-seal side end when said piston head moves towards said piston chamber seal side end, and said valve section is configured to pass fluid into said piston chamber via said seal side aperture in said piston chamber seal side end and to pass fluid out of said piston chamber via said non seal side aperture in said piston chamber non-seal side end when said piston head moves towards said piston chamber non-seal side end;

wherein said valve section is configured to pass fluid in a passageway along a first direction in said passageway both when fluid is entering said first pneumatic line from said piston chamber and when fluid is entering said second pneumatic line from said piston chamber;

whereby fluid always flows in said passageway only along said first direction.

In dependent aspects, the invention further comprises a spring inside or outside said piston chamber; a mechanical coupler and a rotary electric generator; wherein said mechanical coupler mechanically couples said rotatable structure to the rotary electric generator; and an incompressible fluid in said piston chamber.

In further dependent aspects (see FIG. 2), the invention also provides a mechanism to mitigate over-pressure by providing a relief valve, and a mechanism for avoiding over-pressure by providing for a piston shaft extension through the entire axis of the piston chamber.

In another aspect, the invention provides a method of generating electric power by providing a reciprocating force to the piston rod.

In another aspect, the invention provides a method of generating electric power by providing a reciprocating force and a superposed non zero static force to the piston rod.

### BRIEF DESCRIPTION OF THE DRAWING

FIG. 1 is a schematic view of a combination linear rotary generator 100 for converting reciprocating linear force into electrical power; and

FIG. 2 is a schematic view of a combination linear rotary generator 100 for converting reciprocating linear force into electrical power showing additional components relative to FIG. 1.

### DETAILED DESCRIPTION

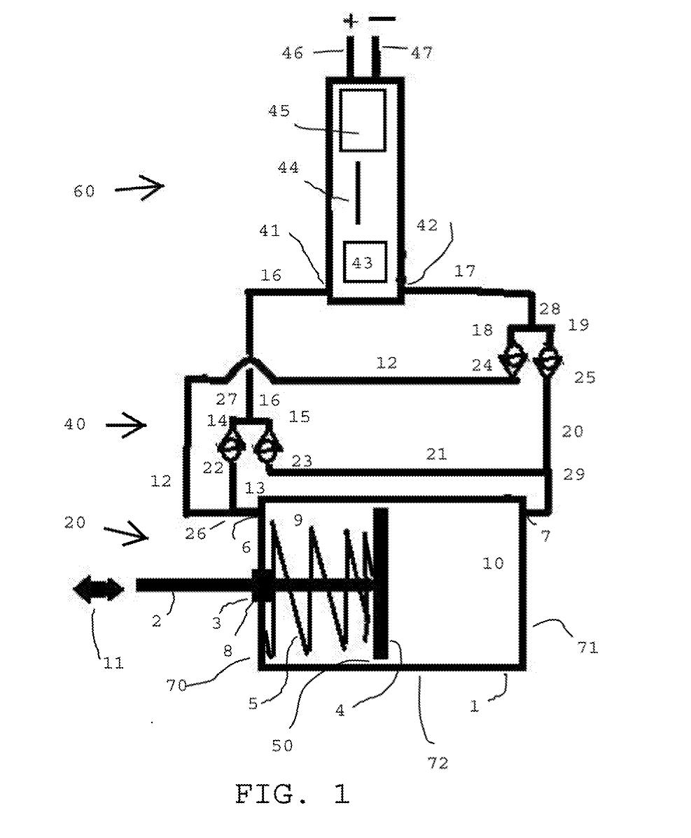

FIG. 1 shows combination linear rotary generator 100 comprising piston section 20, valves section 40, and optional pneumatic generator section 60.

Piston section 20 comprises piston chamber 1, piston rod 2, piston rod seal 3, piston head 4. Piston chamber 1 defines seal side aperture 6, non seal side aperture 7, and piston rod aperture 8. Piston head 4 divides the interior of piston chamber 1 into piston chamber seal side 9 and piston chamber non seal side 10.

Piston rod 2 extends through piston rod aperture 8. Piston rod seal 3 and piston rod 2 form a seal to prevent fluid from within piston chamber seal side 9 from passing through piston rod aperture 8.

Piston rod 2 is mechanically connected with or integral with piston head 4.

Piston rod aperture 8, piston rod 2, and piston rod seal 3 are configured so that piston rod 2 can slidably move within piston rod aperture 8 in response to force applied along the axis of piston rod 2.

Preferably, the peripheral edge of piston head 4 forms piston head seal 50 to the inner surface of piston chamber 2 so that fluid in piston chamber 2 does not leak across this piston head seal 50 as piston head 4 moves within piston chamber 2.

Piston chamber 1 comprises piston chamber seal side end 70, piston chamber non-seal side end 71, and piston chamber peripheral side wall 72. Piston chamber seal side end 70 and piston chamber non-seal side end 71 define opposite ends of piston chamber 1. Piston chamber peripheral side wall 72 extends the entire length between piston chamber seal side end 70 and piston chamber non-seal side end 71, and is impermeable to fluids. Piston chamber seal side end 70 has surfaces that define seal side aperture 6. Piston chamber non-seal side end 71 has surfaces that define non seal side aperture 7. That is, seal side aperture 6 and non seal side aperture 7 are defined in opposite ends of the piston chamber.

Piston head 4 may reciprocate over a very small fraction of the length of piston chamber peripheral side wall 72, such as less than 5 percent, and still force fluid to flow through the valves section to result in unidirectional flow of fluid in passageways in lines 16, 17. Piston head 4 may reciprocate over any larger fraction of the length of piston chamber peripheral side wall 72, such as 30, 50, 70, 80, 90, or substantially the entire length between piston chamber seal side end 70 and piston chamber non-seal side end 71 to result in unidirectional flow of fluid in passageways in lines 16, 17. This large extension ability results from seal side aperture 6 and non seal side aperture 7 being formed on the ends of the piston, instead of along the length of piston chamber peripheral side wall 72.

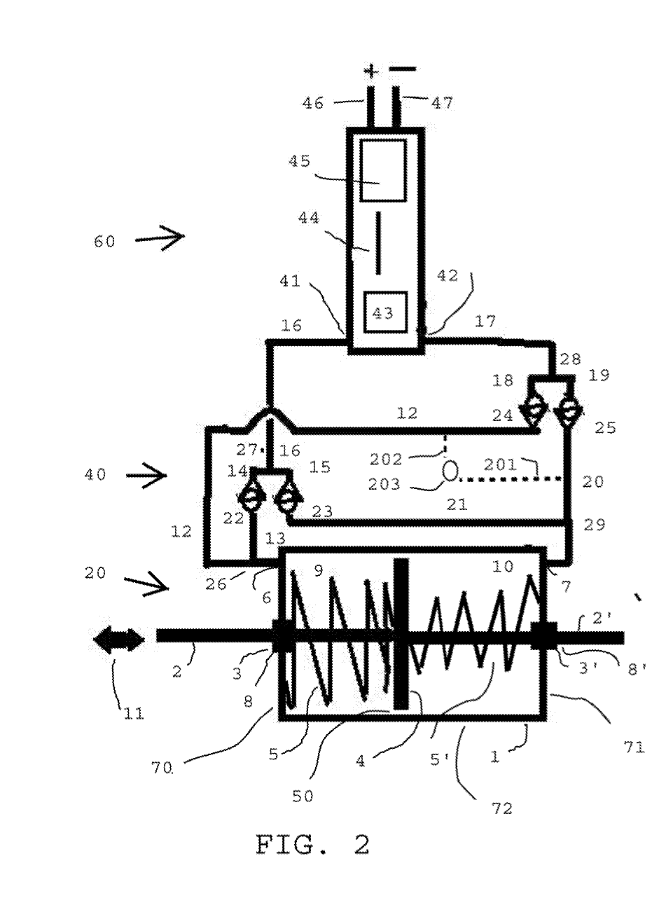

Optionally, piston section 20 also includes spring 5 within the piston chamber between piston head 4 and piston seal side end 70. Spring 5 serves the function of urging the piston head 4 to reside away from contact with the ends of the piston chamber. Optionally, spring 5 is also connected the seal side end of the piston chamber. Optionally, piston section 20 also includes spring 5′ (see FIG. 2) within the piston chamber between piston head 4 and piston non-seal side end 71. Spring 5′ serves the function of urging the piston head 4 to reside away from contact with the ends of the piston chamber. Optionally, spring 5′ is also connected the non-seal side end 71.

In a preferred method of use, piston 2 is connected to a structure that applies a force having a time independent component on piston rod 2 urging piston head 4 away from non-seal side end 71. The force also has an oscillating time dependent component. The oscillating time dependent component results in a reciprocating force on piston head 4. Examples of tensioner structures and fluid flow oscillators that provide a force having an oscillating time dependent component appear in U.S. Pat. No. 8,836,156 titled “Fluid flow energy converter.” U.S. Pat. No. 8,836,156 is incorporated herein by reference in its entirety. Examples of tensioner structures and fluid flow oscillators that provide a force having an oscillating time dependent component appear in U.S. Pat. No. 8,866,321 titled “Articulated-raft/rotary-vane pump generator system.” U.S. Pat. No. 8,866,321 is incorporated herein by reference in its entirety. The oscillating time dependent component of this force that is along the linear direction of motion of piston rod 2 is illustrated by two headed arrow 11, indicating that the oscillator part of the force that is along the direction of motion of piston rod 2 can be in either direction, at any instant of time.

Of course, other driving devices exist that can provide an oscillating force on piston rod 2. For example, water waves.

The structure providing the oscillating force on piston rod 2 (not shown) may be mechanically coupled to piston chamber 20 so that piston chamber 20 resists force exerted on piston chamber 20 by the fluid in piston chamber 20 in response to force applied to piston rod 2. If such a structure is present and mechanically coupled to piston chamber 20, then the function provided by spring 5 and/or spring 5′ is redundant.

Optionally, instead of spring 5 inside piston chamber 20, spring 5 may be outside of piston chamber 2 and mechanically coupled to piston rod 2 or piston chamber 1 or both piston rod 2 and piston chamber 1 to provide a force bias to resist an external force on piston rod 2 or piston chamber 1.

Valves section 40 comprises pneumatic lines 12 to 21 which define pneumatic line T intersections 26-29, and one-way valves 22-25.

Line 12 connects to seal side aperture 6 so that fluid within piston chamber seal side 9 communicates with line 12.

Communicate when referring to fluid means having a passage so that fluid or the pressure carried by fluid can pass between two locations or structures. At T 26, line 12 communicates with line 13. Line 13 terminates at the input to one way valve 22.

Input refers to the aperture of a one way into which fluid is allowed to flow. Output refers to aperture of a one way valve from which fluid is allowed to flow.

Line 14 extends from the output of one way valve 22. Line 14 connects to T 27. Line 16 also connects to T 27 and connects to input 41 of generator section 60. Line 17 connects to output 42 of generator section 60. At T 28, lines 17, 18, and 19 communicate. Line 18 connects to input of one way valve 24. Line 19 connects to input of one way valve 25. Line 20 connects to output of one way valve 25 and connects to non seal side aperture 7. Line 21 connects to T29 and an input of one way valve 23.

Valve section 40 therefore provides for one-way flow of fluid from piston chamber seal side aperture 6 to input 41 (by passing through lines connecting one-way valve 22 to input 41 and being blocked from passage by one way valve 23 and one way valve 24) and one way flow of fluid from output 42 to piston chamber non seal side aperture 7 (by passing through lines connecting through one way valve 25). When piston head 4 moves towards seal side aperture 6, therefore, equal volumes of fluid can flow in a loop from piston chamber seal side 9 to piston chamber non seal side 10.

Valve section 40 also provides for one-way flow of fluid from piston chamber non seal side aperture 7 to input 41 (by passing through lines connecting one-way valve 23 to input 41 and being blocked from passage by one way valve 22 and one way valve 25) and one way flow of fluid from output 42 to piston chamber seal side aperture 6 (by passing through lines connecting through one way valve 24). When piston head 4 moves towards non seal side aperture 7, therefore, equal volumes of fluid can flow in a loop from piston chamber non seal side 10 to piston chamber seal side 9.

Because equal volumes of fluid can flow between piston chamber non seal side 10 and piston chamber seal side 9 for both directions of flow, piston chamber 5 and all lines can be filled with an incompressible fluid.

Optional generator section 60 comprises a rotatable liquid impeller or rotary gas vane structure 43 that is caused to rotate by flow of fluid there through. This fluid is the fluid entering generator section 60 at input 41 and exiting at output 42. Generator section 60 also comprises a mechanical coupler 44 that couples the rotatable structure 43 to rotary electric generator 45. Rotary electric generator outputs a differential potential across electrodes including at least electrodes 46, 47.

Morphological structural variations of the lines and valves are contemplated. The piston chamber; valves section; and generator section may be integrated into a single structure so that pneumatic lines are defined within a single housing. pairs of one way valves 22, 23 and 24, 25 may be replaced with three input valves providing the same valve functions. A base structural support fixing piston chamber 1 relative to oscillating force 11 may exist. Springs may connect such a base to piston rod 2 of piston chamber 1 to provide a spring bias against force.

In operation, compression of spring 5 opposes the force on piston head 4 when piston head 4 is displaced towards piston rod seal 3. When force on piston head 4 oscillates in time, piston head 4 exhibits reciprocating motion in piston chamber 1, such that fluid is alternately forced out of piston chamber seal side 9 returning into piston non seal side 10, and out of piston non seal side 10 returning into piston seal side 9. However, due to the configuration of lines, T's and valves in valve section 40, fluid always flows into input 41 and out of output 42 of generator section 60. Thus, generator section 60 always provides for rotation in the same rotary direction of rotatable liquid impeller or rotary gas vane structure 43 regardless of direction of motion of piston head 4.

Spring 11 is in piston chamber seal side 9 and resists force due to compression. However, spring 11 could be replaced by or supplemented with a spring in piston chamber non seal side 10 which is mechanically connected to piston chamber 1 and piston head 4. Alternative elastomeric material could replace or supplement spring 11. Alternatively any mechanical biasing means such as a spring, elastomer, or pneumatic cylinder could be coupled to piston rod 2 whether inside or outside chamber 1 to offset any constant force component along the direction of piston rod 2 and on piston rod 2. While linear rotary generator 100 is described with respect to a tensioner that includes constant force component along the direction of piston rod 2, other oscillator that have no constant force component along the direction of piston rod 2 may be used with linear rotary generator 100. In those situations, no spring 11 or alternative biasing of piston rod 2 is necessary. However, even in those situations a small spring force (meaning a spring having a low mechanical force constant) may be desirable to bias piston head 4 to near the center of piston chamber 1. One way fluid valves, T's and structures for coupling pneumatic lines to chambers and mechanical housing are old and well known. In a preferred implementation, for low power, the pneumatic lines are formed from flexible polymer tubing, such as a Poly-vinyl Chloride tubing or a thread reinforced Poly-vinyl Chloride tubing; and the working fluid is water or a lower molecular weight oil. Alternatively copper or stainless steel check valves and tubing can be used for higher power and higher fluid pressure embodiments. Check valves having various cracking pressure, reseal pressure, and back pressures are well known in the art and commercially available.

FIG. 2 shows the same elements as FIG. 1 and in addition: piston shaft extension 2′; piston rod seal 3; second spring 5′; piston shaft extension aperture 8′; over pressure relief lines 201, 202; and bidirectional over pressure relief valve 203.

Piston shaft 2′ extend through piston rod seal 3′ and connects to piston 4. Second spring 5 ‘ extends around piston shaft extension 2’ and provides a force opposing movement of piston 4 away from an equilibrium position of second spring 5′. Piston shaft extension 2′ and second spring 5′ result in equal changes in volume in piston chamber seal side 9 and piston chamber non seal side 10 when piston head 4 moves in piston chamber 1. Over pressure relief lines 201, 202 extend in fluid communication from non seal side aperture 7 and seal side aperture 6, respectively, to two-way pressure relief valve 203. Two-way pressure relief valve 203 may be set to allow fluid to pass when pressure across valve 203 exceeds a specified value. Two-way relief valves of plastic, copper, stainless steel are well known and commercially available.

Both the combined elements 201, 202, and 203; the existence of extension 2′, and the spring 5′ address a potential variation in pressure resulting from differences in changes in volume of piston chamber seal side 9 and piston chamber non seal side 10 as piston head 4 moves. variation in pressure resulting from differences in changes in volume of piston chamber seal side 9 and piston chamber non seal side 10 as piston head 4 moves is particularly relevant when using an incompressible fluid within the device.

1. A device for converting reciprocating motion into unidirectional fluid flow, comprising:
a piston section;
a valves section;
wherein the piston section comprising a piston chamber housing a piston head;
wherein said piston chamber (1) comprises a piston chamber seal side end (70), piston chamber non-seal side end (71), and piston chamber peripheral side wall (72);
wherein said piston chamber seal side end and said piston chamber non-seal side end define opposite ends of said piston chamber; wherein said piston chamber seal side end has surfaces that define a seal side aperture (6); wherein said piston chamber non-seal side end has surfaces that define non seal side aperture (7) so that said seal side aperture and said non seal side aperture are in opposite ends of said piston chamber;
wherein said valve section comprises a first pneumatic line connecting to the piston chamber via said seal side aperture in said piston chamber seal side end;
wherein said valve section comprises a second pneumatic line connecting to the piston chamber via said non seal side aperture in said piston chamber non-seal side end;
wherein said valve section comprises at least four one way valves;
wherein said valve section is configured to pass fluid out of said piston chamber via said seal side aperture in said piston chamber seal side end and to pass fluid into said piston chamber via said non seal side aperture in said piston chamber non-seal side end when said piston head moves towards said piston chamber seal side end, and said valve section is configured to pass fluid into said piston chamber via said seal side aperture in said piston chamber seal side end and to pass fluid out of said piston chamber via said non seal side aperture in said piston chamber non-seal side end when said piston head moves towards said piston chamber non-seal side end;
wherein said valve section is configured to pass fluid in a passageway along a first direction in said passageway both when fluid is entering said first pneumatic line from said piston chamber and when fluid is entering said second pneumatic line from said piston chamber;
whereby fluid always flows in said passageway only along said first direction.

2. The device of claim 1 further comprising a spring mechanically connected to at least one of said piston rod; said piston head; and said piston chamber.

3. The device of claim 1 further comprising a mechanical coupler and a rotary electric generator; wherein said mechanical coupler mechanically couples said rotatable element to said rotary electric generator.

4. The device of claim 1 further comprising an incompressible fluid in said piston chamber.

5. A method for converting reciprocating motion into unidirectional fluid flow, comprising:
providing a piston section;
providing a valves section;
wherein the piston section comprising a piston chamber housing a piston head;
wherein said piston chamber (1) comprises a piston chamber seal side end (70), piston chamber non-seal side end (71), and piston chamber peripheral side wall (72);
wherein said piston chamber seal side end and said piston chamber non-seal side end define opposite ends of said piston chamber; wherein said piston chamber seal side end has surfaces that define a seal side aperture (6); wherein said piston chamber non-seal side end has surfaces that define non seal side aperture (7) so that said seal side aperture and said non seal side aperture are in opposite ends of said piston chamber;
wherein said valve section comprises a first pneumatic line connecting to the piston chamber via said seal side aperture in said piston chamber seal side end;
wherein said valve section comprises a second pneumatic line connecting to the piston chamber via said non seal side aperture in said piston chamber non-seal side end;
wherein said valve section comprises at least four one way valves;
wherein said valve section is configured to pass fluid out of said piston chamber via said seal side aperture in said piston chamber seal side end and to pass fluid into said piston chamber via said non seal side aperture in said piston chamber non-seal side end when said piston head moves towards said piston chamber seal side end, and said valve section is configured to pass fluid into said piston chamber via said seal side aperture in said piston chamber seal side end and to pass fluid out of said piston chamber via said non seal side aperture in said piston chamber non-seal side end when said piston head moves towards said piston chamber non-seal side end;
wherein said valve section is configured to pass fluid in a passageway along a first direction in said passageway both when fluid is entering said first pneumatic line from said piston chamber and when fluid is entering said second pneumatic line from said piston chamber;
whereby fluid always flows in said passageway only along said first direction; and
reciprocating the piston head, and thereby generating unidirectional fluid flow.

6. The method of claim 5 further comprising mechanically coupling the unidirectional flow to rotary electric generator to provide electric power.
